(19) United States
(12) Patent Application Publication
(10) Pub. No.: US 2011/0167085 A1
(43) Pub. Date: Jul. 7, 2011

(54) System and Method for Searching for a Target Contact and for Generating a Contact Path

(76) Inventor: Hans M. Haschek, Bad Ischl (AT)

(21) Appl. No.: 13/063,284

(22) PCT Filed: Sep. 14, 2009
(86) PCT No.: PCT/IB09/06978

§ 371 Date: Mar. 10, 2011

(30) Foreign Application Priority Data
Sep. 12, 2008 (US) 61096337

(51) Int. Cl. G06F 17/30

(52) U.S. Cl. 707/769; 707/E17.014

(57) ABSTRACT

A computer-implemented method for searching for a target contact from a plurality of contacts associated with one or more applications is described. A search request for the target contact is received from a searching entity. Information relating to the target contact is retrieved from a contacts database. One or more first contacts are identified in the contacts database that connect to the searching entity. If the one or more contacts do not connect to the target contact, one or more additional contacts are identified in the contacts database until one or more of the additional contacts connect to the target contact. One or more contact paths are generated that extend from the searching entity to the target contact. The one or more contact paths include one or more contacts between the searching entity and the target contact.

### RELATED APPLICATIONS

This application is related and claims priority to U.S. Application No. 61/096,337 filed 12 Sep. 2008 and titled “BestReachII”.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet. Many businesses use one or more computer networks to communicate and share data between the various computers connected to the networks. The productivity and efficiency of employees often requires human and computer interaction.

Users of computer technologies continue to demand that the efficiency of these technologies increase. These demands include demands to improve the ability to communicate with other users of computer technologies. For example, social networking websites allow users to communicate with each other. A user of these sites may establish “contacts” which may be family, friends, co-workers, acquaintances, friends of friends, etc. of the user. In addition, address book features of certain applications (such as email applications) allow a user to store contact information for family, friends, co-workers, etc. The user may access his/her address book to obtain contact information for an individual when he/she desires to contact that particular individual.

The user, however, may desire to contact an individual whose information may not be included in the user's list of contacts (either the contacts from the social networking sites or in the address book feature of other applications). As a result, benefits may be realized by providing systems and methods that enable the user to search for “target contacts” by searching through the contacts of additional users of these networking sites and/or through the contacts listed in the address book of these additional users. In particular, benefits may be realized by providing the user a contact chain (or contact path) that extends from the user to the target contact with contacts of the user and the additional users between the user and the target contact.

### DISCLOSURE OF INVENTION

In one example, a plurality of contacts from multiple databases may be graded. One or more paths may be created to additional contacts using at least some of the plurality of graded contacts. Messages may be sent to the additional contacts through the graded contacts included in one or more paths.

In one embodiment, a first process may validate the login credentials of a user. Once validated, the first process may collect contacts associated with the user that are stored within one or more social networking portals. The user may be a member of each of these social networking portals. Contacts stored with customer relationship management (CRM) systems used by the user may also be collected. The user may then assign a grade to each collected contact. The grade may indicate the level of trust the user has with each contact. The graded contacts of the user may be uploaded to a database along with graded contacts of other users of the first process.

The first user may search for a target contact that is not currently a contact of the first user. The request may be sent to a second process that searches for the target contact within the database. The second process may then generate one or more contact paths that extend from the first user to the target contact. These paths may include one or more contacts of the first user and one or more contacts of other users of the first process until a contact in the path connects to the target contact.

The first user may select one of the contact paths based on the grade assigned to the first contact in the path (which is a contact of the first user). The first user may also select a path based on how may contacts are between the first user and the target contact. Once a path is selected, the first user may create and transmit a message with multiple parts to the first contact in the path. A part of the message may be a message to the target contact from the first user. The first contact may receive the message along with instructions on the identity of the second contact in the path (which is a contact of the first contact). The first contact may forward the message to the second contact. The message may continue to be forwarded through the contact path until the message is received by the target contact. In this manner, the first user (which has no contact with the target contact) is able to send a message to the target contact via one or more contacts of various users of the first process.

According to at least one embodiment, a computer-implemented method for searching for a target contact from a plurality of contacts associated with one or more applications is described. A search request for the target contact is received from a searching entity. Information relating to the target contact is retrieved from a contacts database. One or more first contacts are identified in the contacts database that connect to the searching entity. If the one or more contacts do not connect to the target contact, one or more additional contacts are identified in the contacts database until one or more of the additional contacts connect to the target contact. One or more contact paths are generated that extend from the searching entity to the target contact. The one or more contact paths include one or more contacts between the searching entity and the target contact is described.

In one embodiment, the one or more contact paths are transmitted to the searching entity. The one or more applications may be online social networking portals. Each of the one or more first contacts connected to the searching entity may include a trust classification. In one embodiment, the trust classification indicator indicates a trust relationship, an uncertain relationship, or an untrust relationship between each of the one or more first contacts connected to the searching entity.

One or more contact paths transmitted to the searching entity may include information relating to the one or more first contacts, a trust classification, and a distance indicator. In one example, the distance indicator may indicate a number of contacts between the searching entity and the target contact.

In one configuration, one or more contacts may be downloaded to the contacts database. The one or more downloaded contacts may be associated with a trust classification. Information relating to the searching entity may be downloaded in a users database and the contacts database. In one example, a contact may be prevented from being included in a contact path if a time period indicator indicates the contact is unavailable.

A computer system configured to search for a target contact from a plurality of contacts associated with one or more applications is also described. The computer system may include a processor and memory in electronic communication with the processor. The computer system may also include a contact path generator module configured to receive a search request for the target contact from a searching entity, and retrieve information relating to the target contact from a contacts database. The module may be further configured to identify one or more first contacts in the contacts database that connect to the searching entity, and if the one or more contacts do not connect to the target contact, the module may be configured to identify one or more additional contacts in the contacts database until one or more of the additional contacts connect to the target contact. The module may be further configured to generate one or more contact paths from the searching entity to the target contact. The one or more contact paths may include one or more contacts between the searching entity and the target contact.

A computer-program product for searching for a target contact from a plurality of contacts associated with one or more applications is also described. The computer-program product may include a computer-readable medium having instructions thereon. The instructions may include code programmed to receive a search request for the target contact from a searching entity, and retrieve information relating to the target contact from a contacts database. The instructions may further include programmed to identify one or more first contacts in the contacts database that connect to the searching entity, and if the one or more contacts do not connect to the target contact, the instructions may further include programmed to identify one or more additional contacts in the contacts database until one or more of the additional contacts connect to the target contact. The instructions may further include programmed to generate one or more contact paths from the searching entity to the target contact. The one or more contact paths may include one or more contacts between the searching entity and the target contact.

A computer-implemented method for connecting a searching entity with a target contact through a contact path is also described. Login credentials of the searching entity may be validated. One or more contacts of the searching entity may be collected from one or more applications. A trust classification may be applied to each of the one or more collected contacts. A search request for the target contact may be submitted. One or more contact paths from the searching entity to the target contact may be received. Each contact path may include one or more contacts between the searching entity and the target contact. A message may be transmitted from the searching entity to a first level of contacts connected to the searching entity. If the message has not arrived at the target contact, the transmitted message is forwarded from the first level of contacts to additional contacts on the contact patch until the message arrives at the target contact.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of a client computing device communicating with a server across a network connection to implement the present systems and methods;

FIG. 2 is a block diagram illustrating one embodiment of a client computing device with a contact management process that may gather or collect contact information from various network portals;

FIG. 3 is a block diagram illustrating one embodiment of a client communicating with a server across a network connection in order to request the generation of a contact path;

FIG. 4 is a flow diagram illustrating one embodiment of a method for collecting contact lists from various network portals and grading each contact within the contact lists;

FIG. 5 is a flow diagram illustrating one embodiment of a method for generating a search request for a target contact;

FIG. 6 is a flow diagram illustrating one embodiment of a method for generating a contact path from a searching user to a target contact;

FIG. 7 is one embodiment of a contacts database and various contact paths that may be generated from a searching entity to a target contact;

FIG. 8 is a block diagram illustrating one embodiment of search results that may be provided to a user from the contact path generation process;

FIG. 9 depicts a block diagram of a computer system suitable for implementing the present systems and methods; and

FIG. 10 is a block diagram depicting a network architecture in which client systems, as well as storage servers are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### BEST MODE(S) FOR CARRYING OUT THE INVENTION

In recent years, an increasing number of people are joining one of various online social network portals. Users of these networks may be members of multiple online social network portals. Examples of these portals may include LinkedIn®, XING®, Viadeo®, PLAXO®, and FaceBook®. Each user of these various network portals may create and maintain a list of contacts. A user's list of contacts for a particular network portal may include family members, friends, co-workers, acquaintances, classmates, friends of friends, etc. that are also members of that particular network portal. For example, a member of the social network LinkedIn® may create a list of contacts that includes family members, friends, co-workers, acquaintances, classmates, friends of friends, etc. that are also members of LinkedIn®.

Users of social network portals may also create and maintain a list of contacts in their personal offline networks. Examples of offline networks may include Outlook®, Lotus Notes®, Yahoo®, or any other customer relationship management (CRM) system that utilizes emails. These lists of contacts are commonly placed in an electronic address book associated with each CRM system.

As the number of users of social networking portals and offline networks increase, the total number of contacts across various social networks and offline networks has increased dramatically. As a result, the need exists for a contact search process that enables all the contacts of these various social and offline networks to be searched at the same time. The present systems and methods allow a user of the contact search process to search for an individual that is currently not in the user's list of contacts (i.e., a target contact). This target contact, however, may be in a list of contacts that is associated with another user of the contact search process. The present systems and methods may generate one or more contact paths to allow the searching user to be put in contact with the target contact. The one or more contact paths may include contacts from the searching user's contact list as well as contacts from additional users of the contact search process.

As a result, the present systems and methods eliminate the need for a user to make a “cold call” to a target contact. Instead, the present systems and methods allow a searching user to connect with the target contact by searching most (if not all) of the contacts of the users of a system, and identifying a chain of contacts that stretches from the searching user to the target contact. This chain of contacts may then forward a message from the searching user to the target contact along the chain so that the target contact receives the searching user's message from an established contact of the target contact.

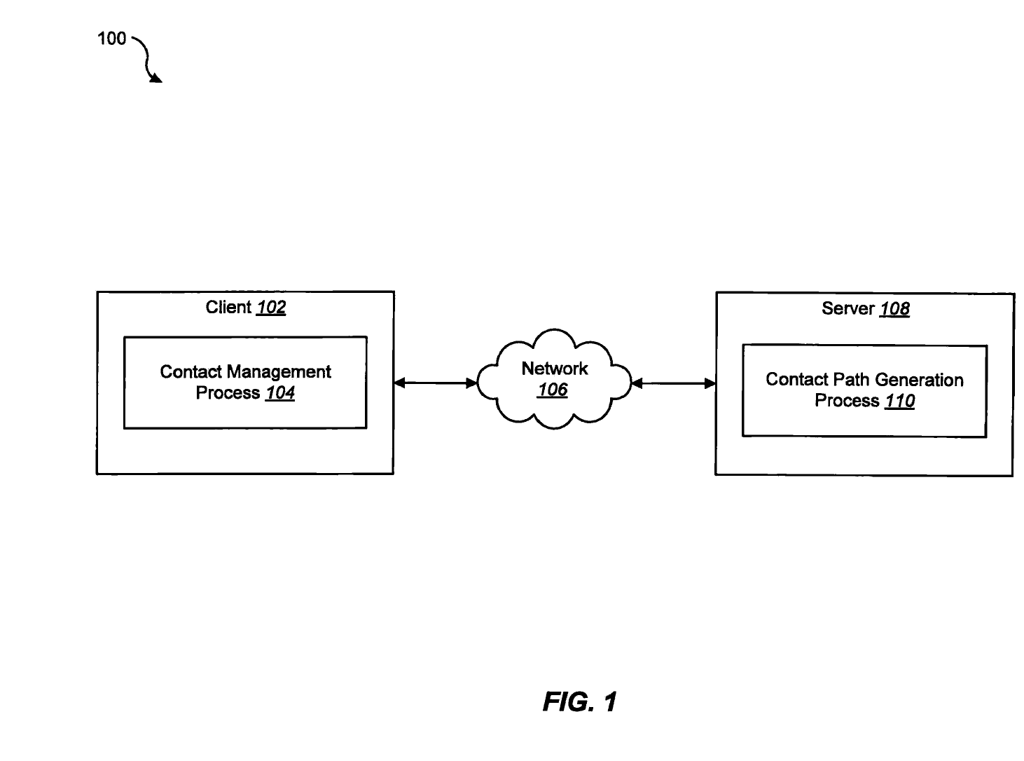

FIG. 1 is a block diagram illustrating one embodiment of a client computing device 102 communicating with a server 108 across a network connection 106 to implement the present systems and methods. In one configuration, the client 102 may be a personal computer (PC), a laptop, a personal digital assistant (PDA), or any other type of computing device. The client 102 may include a contact management process 104. The management process 104 may allow a user to manage lists of contacts from various social networking portals and offline networks. For example, the management process 104 may retrieve or collect the lists of contacts the user has created for each social networking portal and offline network the user is a member of.

Once a user's contacts are collected by the management process 104 from each social networking portal and offline network the user is a member of, the contact management process 104 may allow the user to grade or rank each contact. In one embodiment, the user may grade each contact as a trusted contact, an uncertain contact, or an untrusted contact. For example, the user may grade a personal contact as a trusted contact, a friend of a friend as an uncertain contact, etc. In one example, each list of contacts collected by the process 104, and graded by the respective user, may be uploaded to the server 108. In other words, the server 108 may store graded contacts for multiple users of the contact management process 104.

In one configuration, the server 108 may include a contact path generation process 110. In one embodiment, the process 110 may search through lists of contacts associated with multiple users in order to generate one or more paths to a target contact. For example, the server 108 may receive a search request from the contact management process 104 to search for a target contact. The process 110 may search multiple contact lists associated with multiple users of the management process 104 to locate the target contact. The process 110 may generate one or more paths to the target contact. These paths may be transmitted to the management process 104 and provided to the user searching for the target contact. Details regarding the contact management process 104 and the contact path generation process 110 will be described below in more detail.

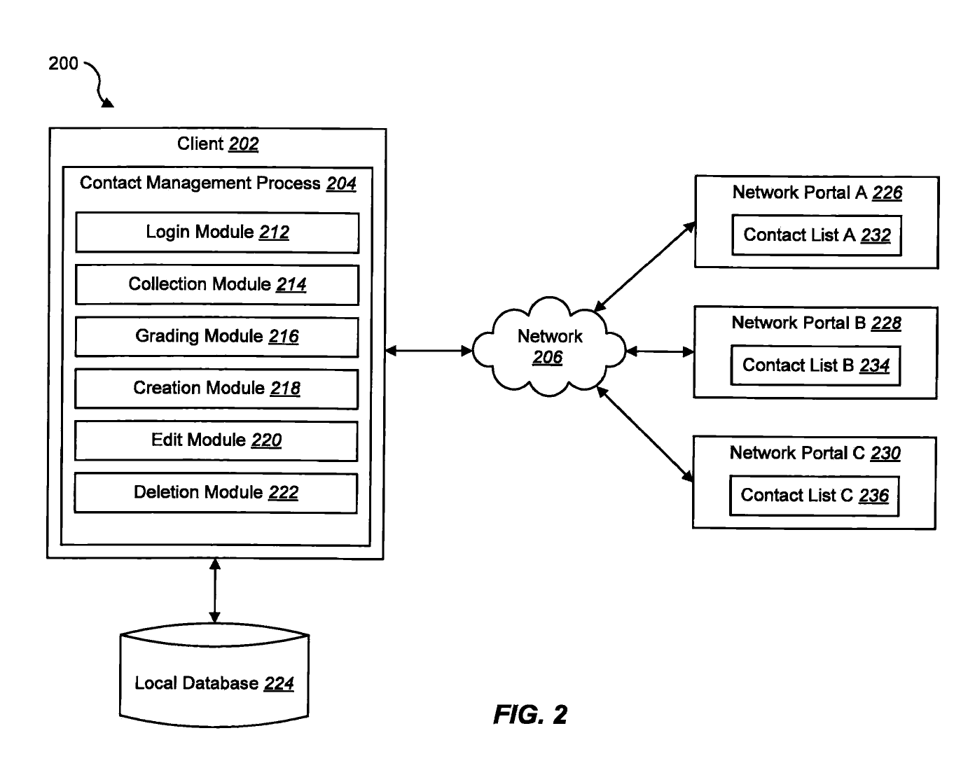

FIG. 2 is a block diagram illustrating one embodiment of a client computing device 202 with a contact management process 204 that may gather or collect contact information from various network portals 226, 228, 230. In one configuration, the contact management process 204 may communicate with the various network portals 226, 228, 230 across a network connection 206. In one example, the network 206 may be the Internet. The various network portals 226, 228, 230, may be online social networking sites and/or offline networks, such as CRM systems. In another embodiment, the network portals 226, 228, 230 may include application programming interfaces (APIs) that allow the network portals 226, 228, 230 to run the contact management process 204 in the background of the applications associated with the portals 226, 228, 230.

In one configuration, each network portal 226, 228, 230 may include a contact list 232, 234, 236 that is associated with a user of the portals 226, 228, 230. While only one contact list is illustrated in each portal, it is to be understood that each network portal may include more or less contact lists. In other words, the portals 226, 228, 230 may include a contact list for each user that uses (or is a member of) the portals. In one embodiment, the contact lists 232, 234, 236 may include names of individuals and their contact information. Some or all of the contact lists 232, 234, 236 may be identical. For example, a user of network portal A 226 may create a contact list A 232. The user may also be a member of network portal B 228 and may create a contact list B 234. The contact list A 232 and the contact list B 234 may include identical contacts because they are the contacts for the same user. In another embodiment, the contact lists 232, 234, 236 may be different and include different contacts associated with the user.

The contact management process 204 may include a login module 212 that allows a user to login or access the contact management process 204. In one example, the login module 212 may receive and analyze login credentials provided by a user. These login credentials may include a user name and password. After the credentials are verified, the user may select to store the login credentials in a local database 224 so that the user is not required to re-enter the credentials each time he/she logs into the process 204. In addition, after a user establishes an account with the contact management process 204, the user's information (contact information, etc.) may be uploaded to a user database and a contacts database that may be maintained by the server 108.

The contact management process 204 may also include a collection module 214. The collection module 214 may communicate with the various network portals 226, 228, 230 that the user is a member of. Each of the portals 226, 228, 230 may require login credentials for the user. The user may provide the login credentials for each portal 226, 228, 230 to the collection module 214. The collection module 214 may then access the user's contact lists 232, 234, 236 in each portal 226, 228, 230 using the login credentials provided by the user for each respective portal.

The management process 204 may further include a grading module 216. Once the collection module 214 has collected each contact list 232, 234, 236, the grading module 216 may allow the user to assign a grade or a classification to each contact within the lists 232, 234, 236. For example, the user may grade each contact as a trusted contact, an uncertain contact, or an untrusted contact as previously explained. In one embodiment, a grade may be assigned to contacts associated with social networking portals. Contacts collected from offline networks (e.g., Outlook®, etc.) may already have a corresponding grade assigned to them.

The contact management process 204 may also include a creation module 218 that may allow a user to manually create a contact that was not collected by the collection module 214. An edit module 220 may allow the user to edit any of the contacts gathered by the collection module 214 or any contacts manually created by the user through the creation module 218. Further, the contact management process 204 may include a deletion module 222 that may allow the user to delete any of the contacts gathered by the collection module 214 or manually created by the user via the creation module 218.

In one embodiment, after the user has graded each contact within the collected lists 232, 234, 236, the management process 204 may upload each graded contact to the server 108. For example, each graded contact may be stored in a contacts database that may be accessed by the contact path generation process 110, as will be described below. Edits or changes to the information stored in the user database 348 or the contacts database 350 may be synchronized with the local database 224 so that the information accessed by the server 108 and by the client 102 may be in sync.

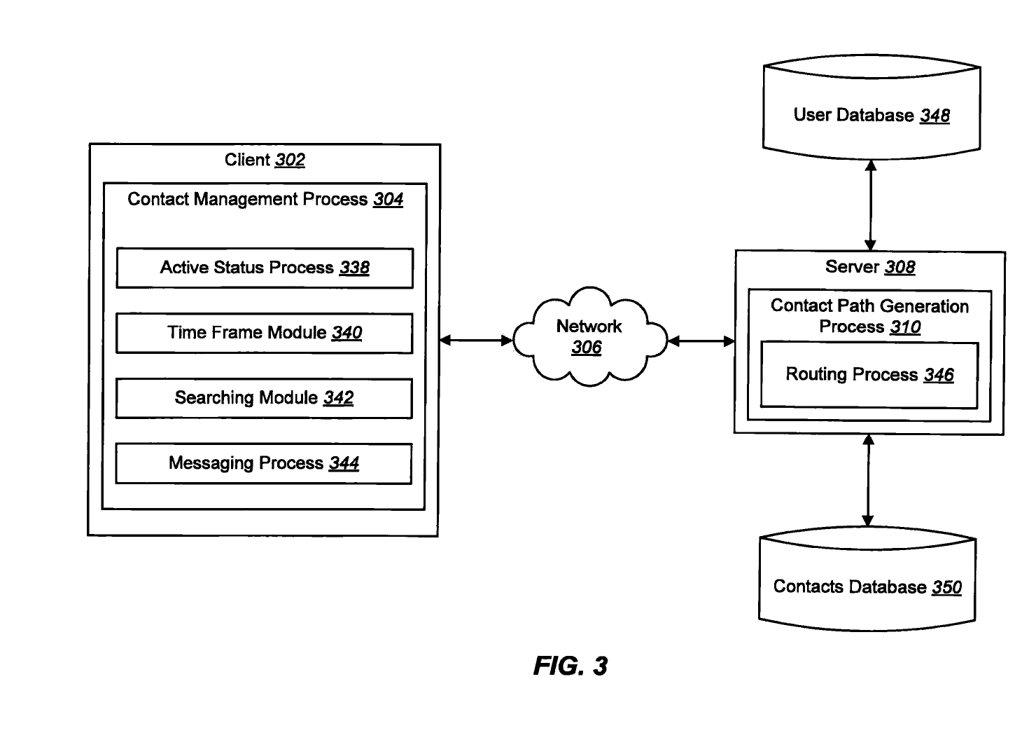

FIG. 3 is a block diagram illustrating one embodiment of a client 302 communicating with a server 308 across a network connection 306 in order to request the generation of a contact path to a target contact. In one configuration, the client 302 may include a contact management process 304 as previously described that may include addition modules and processes than previously described above. For example, the process 304 may further include an active status process 338. The status process 338 may indicate to the server 308 when a user is logged into the contact management process 304. In other words, the status process 338 may indicate to the server 308 when the user is “online” with the management process 304. Messages generated by the server 308 that have not been downloaded by the contact management process 304 because the user was not logged into the management process 304 may now be downloaded by the active status process 338.

In addition, the contact management process 304 may include a time frame module 340. The time frame module 340 may allow the user to indicate time frames or time periods in which the user may not have access to the contact management process 304. For example, the user may enter days that he/she will be away on vacation and not logged into the management process 304.

In one configuration, the contact management process 304 may also include a searching module 342. The searching module 342 may allow the user (i.e., the searching user) to enter information regarding a target contact that the user desired to connect with. The target contact may be an individual that is not currently included in any of the contact lists associated with the searching user. For example, the searching user may enter the name, company, etc. of the target contact into the searching module 342. The searching module 342 may then transmit a search request to the server 308 across the network connection 306.

The server 308 may include a contact path generation process 310 as previously described. The generation process 310 may include a routing process 346 that may generate a contact path that begins with the searching user and ends with the target contact specified in the search request received from the searching module 342. As previously explained, information for each user that uses the management process 304 may be stored in a user database 348. The user's information may also be stored in a contacts database 350. Each of these users may grade their respective contacts after the collection module 214 has collected each of the user's contacts from the various portals and networks the user is a member of. Each of these graded contacts may be uploaded and stored in the contacts database 350 that may be accessed and searched by the routing process 346. In addition, the time periods or time frames indicating when the user may be unavailable may also be uploaded to the contacts database 350. Further, each user may also specify certain “wants” and “haves” that may be stored in the user database 348 and the contacts database 350 in order to allow a form of targeted marketing when searching for a particular target contact.

In one embodiment, the routing process 346 may search the contacts database 350 for the target contact indicated in the search request received from the searching module 342. If the target contact is stored in the contacts database 350, the routing process 346 may generate one or more contact paths that begin with the searching user and end at the target contact. These paths may include contacts of the searching user and contacts associated with other users of the contact management process 304. The routing process 346 may then transmit the one or more contact paths to the contact management process 304. The management process 304 may then provide the one or more paths to the searching user and the searching user may select which contact path to use to connect with the target contact.

In one configuration, the management process 304 may also include a messaging process 344. After the searching user has selected which contact path to use to connect with the target contact, the messaging process 344 may generate and transmit one or more messages to the various contacts that may be included in the selected contact path. For example, the selected path may include the searching user, a first contact that is associated with the searching user, a second contact that may not be associated with the searching user (the first contact and the second contact may be contacts with each other), and the target contact (the second contact and the target contact may be contacts with each other). The messaging process 344 may create and transmit one or more messages from the searching user, to the first contact, to the second contact, and finally to the target contact. The message received by the first contact, the second contact, and the target contact may include two parts. For example, the first part of the message received by the first contact may include a message from the searching user. The second part (which may be inaccessible by the first user) may be a message to the target contact. The first contact may forward the second part of the message to the second contact. The second contact may receive a message that include the forwarded second part as well as a message from the first contact. Similarly, the second contact may forward the second part to the target contact as well as a personal message to the target contact. In one embodiment, the message may also include plain text documents or attachments. In this manner, the target contact may receive a message from the searching user via the contact path generated by the routing process 346.

At any time along the contact path, the recipient of the messages may reject or elect to not forward the messages to the next contact in the path. If this occurs, the recipient may send a response to the sender of the message in the contact path explaining why the messages were not forwarded to the next contact in the path.

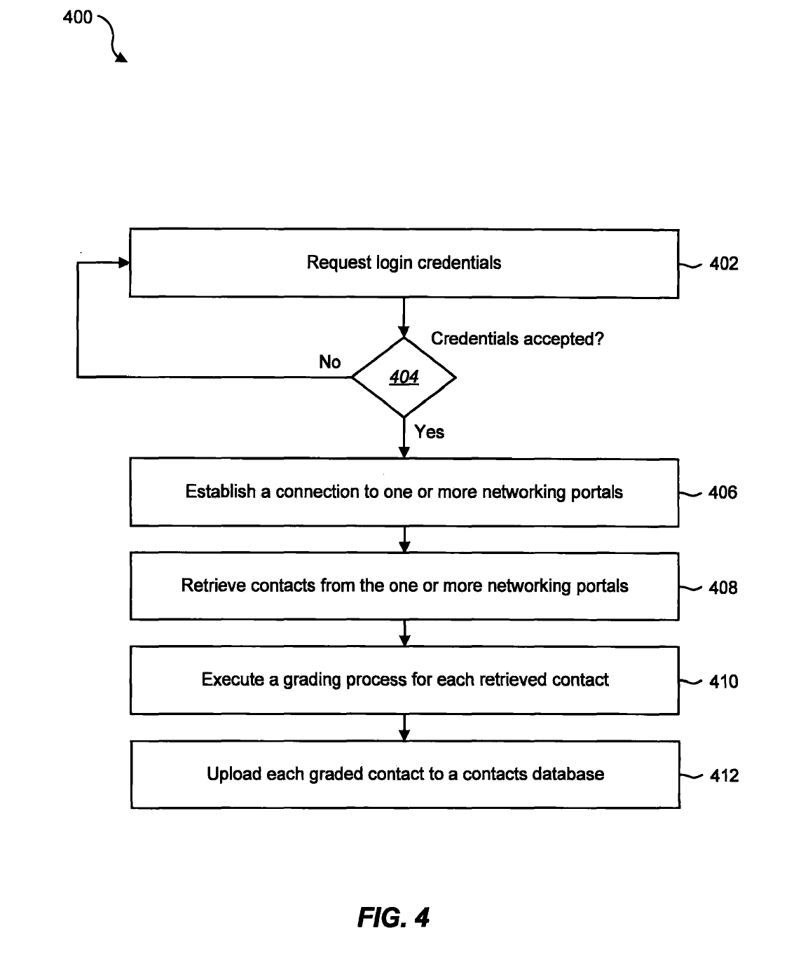

FIG. 4 is a flow diagram illustrating one embodiment of a method for collecting contact lists of a user from various network portals and assigning a grade to each contact within the contact lists. In one configuration, the method 400 may be implemented by the contact management process 104. In one configuration, login credentials of the user may be requested 402. The credentials may determine whether the user has access to the contact management process 104. The process 104 may be a standalone process or a process running in the background of an external application (or networking portal) through APIs.

In one embodiment, a determination 404 may be made as to whether the login credentials are accepted. If the credentials are not accepted, the method 400 may return to request 402 the login credentials again from the user. If, however, the credentials are accepted, a connection to one or more networking portals may be established 406. The user may be a member of the one or more networking portals. In one embodiment, the portals may be online social networking portals and/or offline networks. In one example, contact lists from the one or more networking portals may be retrieved 408. In other words, lists of contacts may be within each of the networking portals. These lists of contacts may be associated with the user.

In one configuration, a grading process may be executed 410 for each retrieved contact. For example, the user may manually grade each contact retrieved from the one or more networking portals. In another embodiment, the grading process may be executed 410 automatically for each retrieved contact. For example, characteristics of each contact may be analyzed and a grade may be applied to the contact based on the analysis of the characteristics. Examples of characteristics may include the length of time a contact has existed in a list of contacts, how often the user has communicated with the contact, etc. In one embodiment, the grading process may apply a classification to each contact that indicates the level of trust the user has for the contact. In other words, the user may apply a trust grade, an uncertain grade, or an untrust grade to each contact within the retrieved contact list. After the grading process of each contact, the graded contacts may be uploaded 412 to a contacts database. A routing process 346 may access the database to generate a contact path to a target contact as previously described.

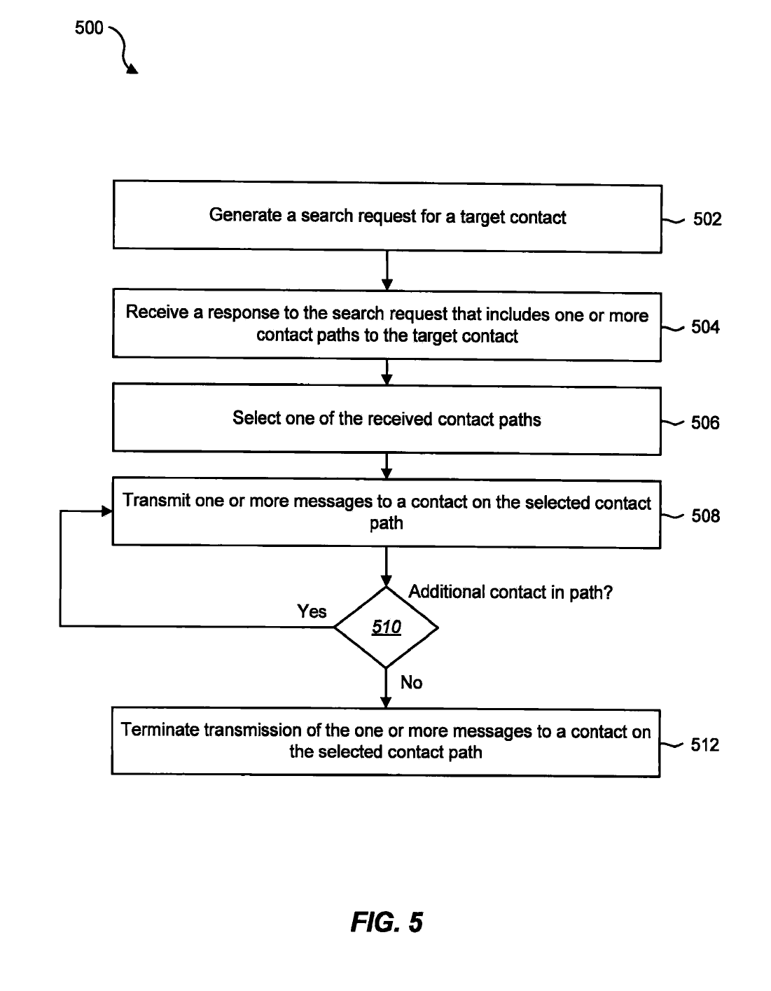

FIG. 5 is a flow diagram illustrating one embodiment of a method for connecting with a target contact through a contact path. In one embodiment, the method 500 may be implemented by the contact management process 104. In one configuration, a search request may be generated 502 for a target contact. For example, a searching user may provide identification information for the target contact, and the information may be included in a search request that may be transmitted to the contact path generation module 110.

A response to the search request may be received 504. In one configuration, the response may include one or more contact paths to the target contact. The contact paths may begin with the searching user and end at the target contact with one or more contacts of the searching user and contacts of non-searching users between. The one or more paths may indicate the level of trust between the searching user and one or more contacts included in the path. Each path may also indicate the number of contacts that exist between the searching user and the target contact.

One of the received contact paths may be selected 506. In addition, one or more messages may be transmitted 508 to each contact on the selected contact path. For example, a message may include a first part directed to the next contact on the contact path, and a second part that may be directed to the target contact. A determination 510 may be made as to whether additional contacts are in the contact path. If it is determined 510 that additional contacts are in the selected contact path, one or more messages may be transmitted 508 to the next contact on the path. If, however, it is determined 510 that additional contacts do not exist in the selected contact path (the messages have reached the target contact), transmission of the one or more messages may be terminated 512.

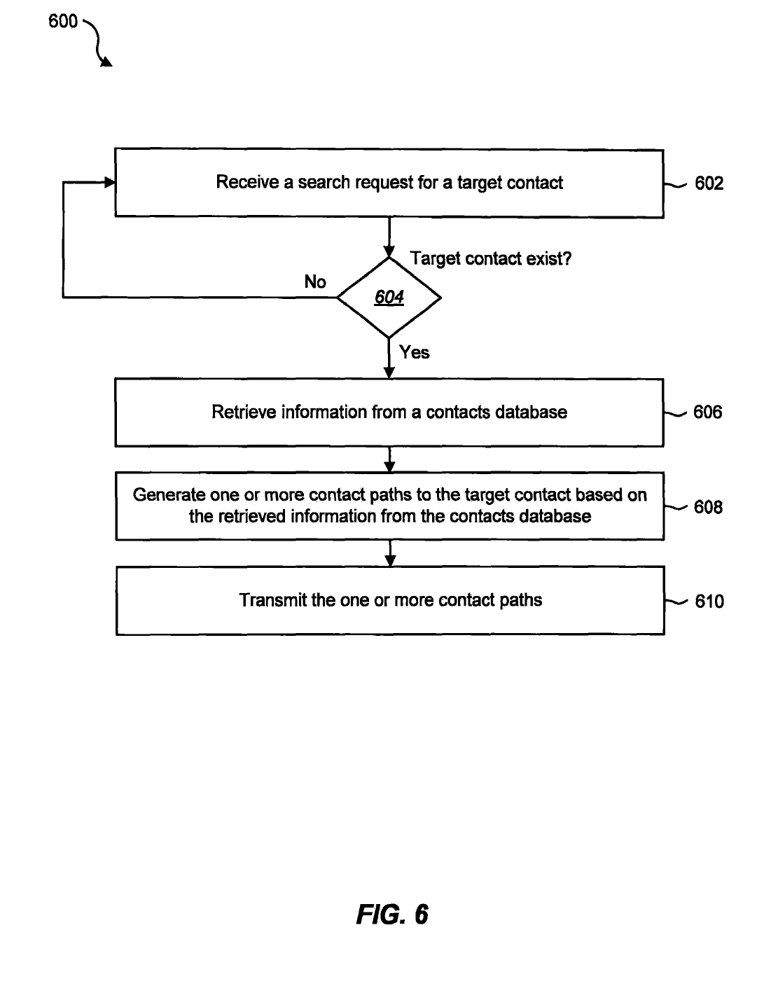

FIG. 6 is a flow diagram illustrating one embodiment of a method for generating a contact path from a searching user to a target contact. In one embodiment, the method 600 may be implemented by the contact path generation process 110. In particular, the method 600 may be implemented by the routing process 346.

In one configuration, a search request for a target contact may be received 602. A determination 604 may be made as to whether the target contact listed in the search request exists. For example, the contact path generation process 110 may search for the target contact within the contacts database 350. For example, the target contact may be another user of the contact management process 104 and his/her information may be stored in the user database 348 and the contacts database 350. Alternatively, the target contact may be a contact of another user of the management process 350 and may exist only in the contacts database 350 as a contact of that additional user. If it is determined 604 that the target contact does not exist, the method 600 may notify the sender of the response that the target contact does not exist and may wait to receive 602 another search request for a different target contact. If, however, it is determined 604 that the target contact exists, the method 600 may retrieve 606 information from the contacts database 350 for the target contact.

Once information has been retrieved 606 from the contacts database relating to the target contact, one or more contact paths to the target contact may be generated 608. The one or more contact paths may be generated 608 by analyzing information relating to additional contacts in the contacts database. For example, the routing process 346 may identify a first contact that is connected to the target contact, then a second contact that is related to the first contact, etc. until the path reaches an initial contact of the searching user. The routing process 346 may then determine whether alternative contact paths exist. In creating a path, the routing process 346 may determine whether to use a particular contact in the database 350 based on the availability of the contact. For example, a particular contact may include time frame information that indicates the contact may be unavailable to receive and forward messages. If the contact is unavailable, the routing process 346 may not generate a path that includes that contact.

In one embodiment, the one or more contact paths may be transmitted 610. For example, the one or more contact paths may be transmitted 610 to the contact management process 104 across a network connection 106. The searching user may select one of the transmitted paths. In addition, the searching user may transmit a message to the initial contact (that also includes a message to the target contact) on the path requesting that this initial contact forward the target contact message to the next contact in the path.

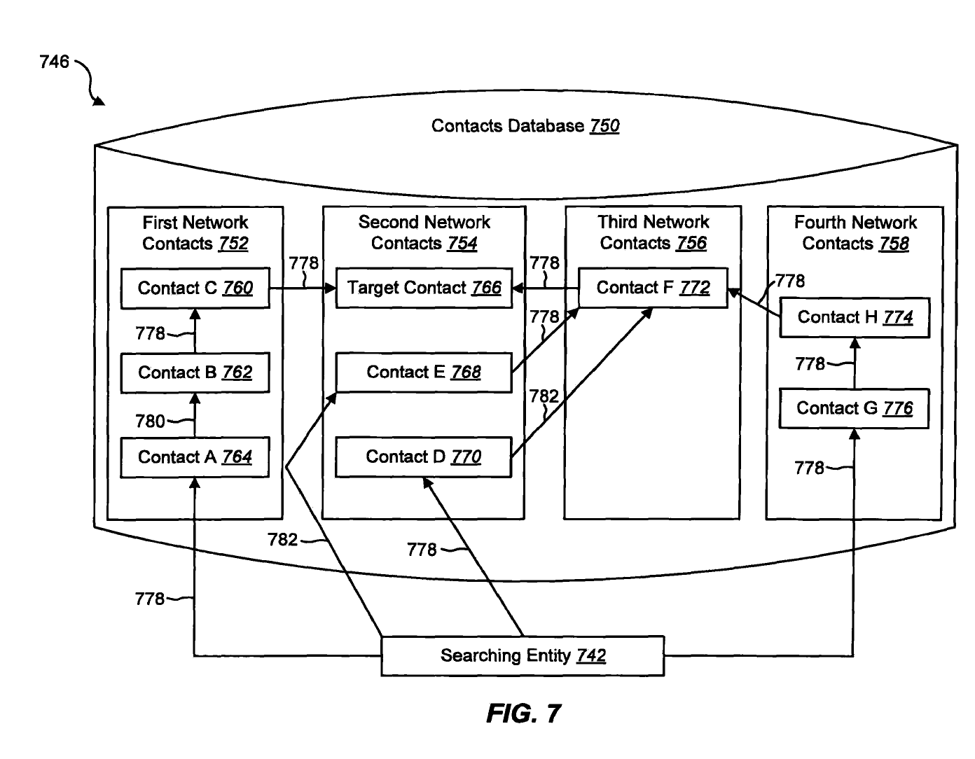

FIG. 7 is one embodiment of a routing process 746 searching a contacts database 750 to generate various contact paths from a searching entity 742 (e.g., searching user) to a target contact 766. In one configuration, the searching entity 742 may be a user of the contact management process 104. The contacts database 750 may include a one or more contacts associated with one or more network portals. For example, contacts of a first network 752 may include contact A 764, contact B 762, and contact C 760. In one example, contacts of a second network 754 may include contact E 768 and contact D 770. In addition, one of the contacts associated with the second network 754 may be a target contact 766 that is being searched for by the searching entity 742.

As illustrated, contacts of a third network 756 may include a contact F 772. In addition, contacts associated with a fourth network 758 may include a contact H 774 and a contact G 776. In one configuration, one or more contact paths may be generated that extend from the searching entity 742 to the target contact 766. For example, a first contact path may extend from the searching entity 742 to contact A 764, contact B 762, contact C 760 and, finally, the target contact 766. In addition, a second contact path may extend from the searching entity 742 to contact E 768, contact F 772, and finally the target contact 766. Further, a third contact path may extend from the searching entity 742 to contact D 770, contact F 772, and the target contact 766. Finally, a fourth contact path may exist that extends from the search entity 742 to contact G 776, contact H 774, contact F 772, and the target contact 766.

In one embodiment, each of the first contacts in the various paths (i.e., contact A 764, contact D 770, contact E 768, and contact G 776) may be contacts of the searching entity 742. In addition, the relationship between the searching entity 742 and the first contact in each contact path may be classified as trusted 778, uncertain 782, or untrusted 780 based on the grading process previously described. For example, the relationship between the searching entity 742 and contact A 764, contact D 770, and contact G 776 may be a trusted 778 relationship. In other words, the searching entity 742 may have previously graded these contacts and assigned a trusted grade 778 to these contacts. An uncertain relationship 782 may exist between the search entity 742 and contact E 768. In addition, relationships may exist between the additional contacts in each path. For example, an untrust 780 relationship may exist between contact A 764 and contact B 762. In addition, an uncertain 782 relationship may exist between contact D 770 and contact F 772.

In one example, the fourth contact path extending through contact G 776, contact H 774, contact F 772, and the target contact 766 may be a fully trusted contact path because the relationship between the searching entity 742 and the first contact 776 and each contact after that is a trusted 778 relationship.

The searching entity 742 may decide which contact path to use based upon the relationship between the searching entity 742 and the first contact in a contact path as well as the number of contacts that exist between the entity 742 and the target contact 766. For example, the searching entity 742 may select the third contact path through contact D 770 because a trust relationship 778 exists between the searching entity 742 and contact D 770. In addition, the third contact path includes the least amount of hops (or contacts) between the searching entity 742 and the target contact 766. In this example, the third contact path includes two hops (contact D 770 and contact F 772). The searching entity 742, however, may desire to select the fourth contact path because each relationship between the contacts is a trusted relationship, even though there is one extra hop than the third contact path.

In one embodiment, the searching entity 742 may only be provided the relationship grade between the searching entity 742 and the first contact in each contact path. For example, the searching entity 742 may only be aware of the relationship grade between the entity 742 and contact A 764, contact E 768, contact D 770, and contact G 776. In addition to the relationship grade between the entity 742 and the first contact, the searching entity 742 may also be provided the number of hops until the target contact 766 is reached for each path. In another embodiment, the searching entity 742 may be provided information for each complete contact path as illustrated in FIG. 7.

In one embodiment, the searching entity 742 may initiate the messaging process 344 once a contact path is selected. The messaging process 344 may allow the searching entity 742 to send a message with multiple parts to the first contact in the selected contact path. For example, the searching entity 742 may select the fourth contact path that begins with contact G 776. A message that contains multiple parts may be transmitted to contact G 776 from the searching entity 742. A first part of the message may be a message directed to contact G 776 from the searching entity 742 that requests contact G 776 to forward the message to the next contact in the path (i.e., contact H 774). A second part of the message sent to contact G 776 may be a message directed to the target contact 766.

Upon receiving the message, contact G 776 may also receive the identify of the next contact in the path (i.e., contact H 774). Because contact G 776 and contact H 774 are contacts with each other, contact G 776 may elect to forward the second part of the original message (i.e., the message directed to the target contact 766) to contact H 774. Contact G 776 may also include a personal message to contact H 774. Contact G 776, however, may decline to forward the message to contact H 774. In one embodiment, contact G 776 may send a response to the searching entity 742 explaining why the message was not forwarded to contact H 774.

In a similar manner, contact H 774 may then decide whether to forward the original message to the target contact 766 along with a personal message to contact F 772 (contact H 774 and contact F 772 are contacts with each other). Contact F 772 may then decide whether to forward the original message to the target contact 766 along with a personal message to the target contact 766 because contact F 772 and the target contact 766 are contacts with each other. In this manner, target contact 766 may receive the original message from the searching entity 742 via a known (or somewhat known) contact (i.e., contact F 772).

In one configuration, the messages may be transmitted along the contact path through a peer-to-peer (P2P) connection. For example, if the searching entity 742 and contact G 776 are both members of the contact management process 104, a P2P connection may be established and the message from the searching entity 742 may be transmitted to contact G 776 via this connection. If, however, contact G 776 is not a member of the management process 776, and a P2P connection is not established, the message may be transmitted to contact G 776 via email or some other means. For example, the messages may be sent via the server 108 to an email server associated with an email address of the intended recipient in the contact path.

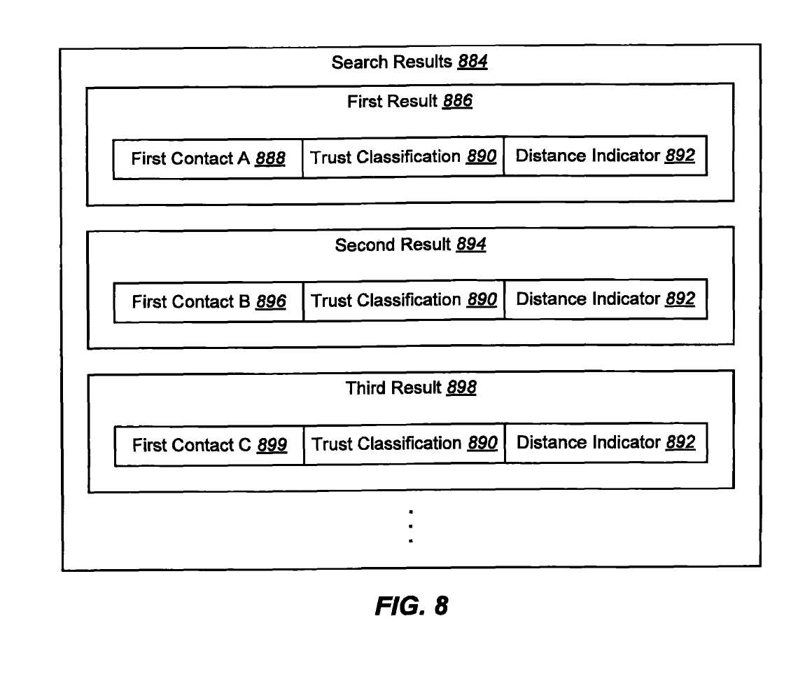

FIG. 8 is a block diagram illustrating one embodiment of search results 884 that may be provided to a searching user that may illustrate the one or more contact paths generated by the contact path generation process 110. In one example, the search results 884 may include three results (i.e., contact paths) 886, 894, 898. The results may be displayed randomly or in a particular order based on certain characteristics of the results, such as a trust classification 890 and/or a distance indicator 892, which will be explained below.

In one configuration, the search results 884 may provide multiple contact paths to a target contact. For example, the first result 886 may include a first contact A 888. The first contact A 888 may be an individual that is a contact of the searching user. The first contact A 888 may also be associated with a trust classification 890. The classification 890 may be a color code to indicate whether first contact A 888 has been previously graded by the searching user as a trusted contact, and uncertain contact, or an untrusted contact. The first result 886 may also include a distance indicator 892. The indicator 892 may indicate to the number of contacts (or hops) that exist on the contact path between the searching user and the target contact. The second and third results 894, 898 may include similar components as the first result 886. The searching user may then select one of the results 886, 894, 898. In other words, the user may select one of the multiple contact paths to attempt to establish contact with the target contact.

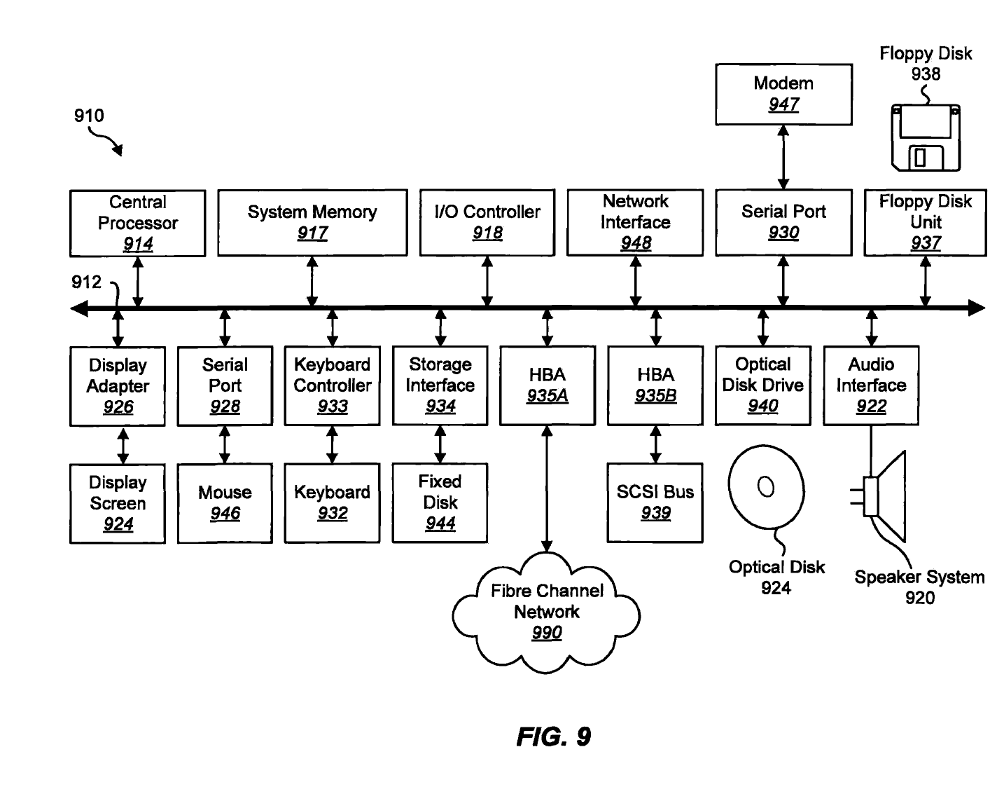

FIG. 9 depicts a block diagram of a computer system 910 suitable for implementing the present systems and methods. Computer system 910 includes a bus 912 which interconnects major subsystems of computer system 910, such as a central processor 914, a system memory 917 (typically RAM, but which may also include ROM, flash RAM, or the like), an input/output controller 918, an external audio device, such as a speaker system 920 via an audio output interface 922, an external device, such as a display screen 924 via display adapter 926, serial ports 928 and 930, a keyboard 932 (interfaced with a keyboard controller 933), a storage interface 934, a floppy disk drive 937 operative to receive a floppy disk 938, a host bus adapter (HBA) interface card 935A operative to connect with a Fibre Channel network 990, a host bus adapter (HBA) interface card 935B operative to connect to a SCSI bus 939, and an optical disk drive 940 operative to receive an optical disk 942. Also included are a mouse 946 (or other point-and-click device, coupled to bus 912 via serial port 928), a modem 947 (coupled to bus 912 via serial port 930), and a network interface 948 (coupled directly to bus 912).

Bus 912 allows data communication between central processor 914 and system memory 917, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 910 are generally stored on and accessed via a computer readable medium, such as a hard disk drive (e.g., fixed disk 944), an optical drive (e.g., optical drive 940), a floppy disk unit 937, or other storage medium. Additionally, applications can be in the form of electronic signals modulated in accordance with the application and data communication technology when accessed via network modem 947 or interface 948.

Storage interface 934, as with the other storage interfaces of computer system 910, can connect to a standard computer readable medium for storage and/or retrieval of information, such as a fixed disk drive 944. Fixed disk drive 944 may be a part of computer system 910 or may be separate and accessed through other interface systems. Modem 947 may provide a direct connection to a remote server via a telephone link or to the Internet via an internet service provider (ISP). Network interface 948 may provide a direct connection to a remote server via a direct network link to the Internet via a POP (point of presence). Network interface 948 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present disclosure. The devices and subsystems can be interconnected in different ways from that shown in FIG. 9. The operation of a computer system such as that shown in FIG. 9 is readily known in the art and is not discussed in detail in this application. Code to implement the present disclosure can be stored in computer-readable storage media such as one or more of system memory 917, fixed disk 944, optical disk 942, or floppy disk 938. The operating system provided on computer system 910 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

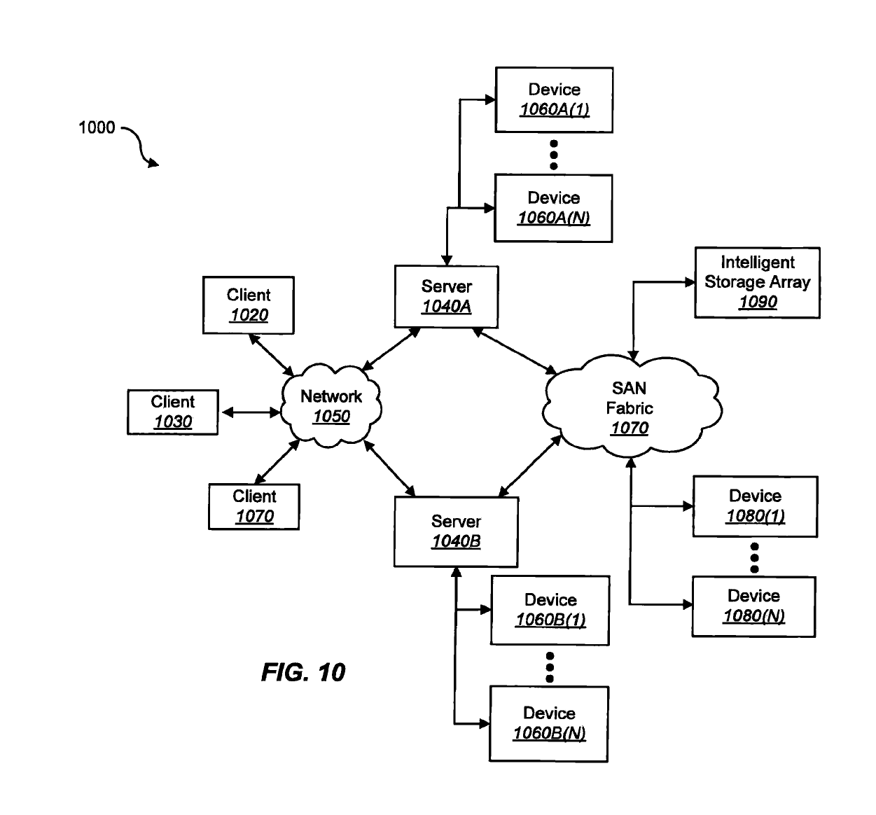

FIG. 10 is a block diagram depicting a network architecture 1000 in which client systems 1010, 1020 and 1030, as well as storage servers 1040A and 1040B (any of which can be implemented using computer system 1010), are coupled to a network 1050. The storage server 1040A is further depicted as having storage devices 1060A(1)-(N) directly attached, and storage server 1040B is depicted with storage devices 1060B(1)-(N) directly attached. SAN fabric 1070 supports access to storage devices 1080(1)-(N) by storage servers 1040A and 1040B, and so by client systems 1010, 1020 and 1030 via network 1050. Intelligent storage array 1090 is also shown as an example of a specific storage device accessible via SAN fabric 1070.

With reference to computer system 910, modem 947, network interface 948 or some other method can be used to provide connectivity from each of client computer systems 1010, 1020 and 1030 to network 1050. Client systems 1010, 1020 and 1030 are able to access information on storage server 1040A or 1040B using, for example, a web browser or other client software (not shown). Such a client allows client systems 1010, 1020 and 1030 to access data hosted by storage server 1040A or 1040B or one of storage devices 1060A(1)-(N), 1060B(1)-(N), 1080(1)-(N) or intelligent storage array 1090. FIG. 10 depicts the use of a network such as the Internet for exchanging data, but the present disclosure is not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for searching for a target contact from a plurality of contacts associated with one or more applications, comprising:
receiving a search request for the target contact from a searching entity;
retrieving information relating to the target contact from a contacts database;
identifying one or more first contacts in the contacts database that connect to the searching entity;
if the one or more contacts do not connect to the target contact, identifying one or more additional contacts in the contacts database until one or more of the additional contacts connect to the target contact; and
generating one or more contact paths from the searching entity to the target contact, wherein the one or more contact paths include one or more contacts between the searching entity and the target contact.

2. The method of claim 1, transmitting the one or more contact paths to the searching entity.

3. The method of claim 1, wherein the one or more applications comprise online social networking portals.

4. The method of claim 1, wherein each of the one or more first contacts connected to the searching entity comprises a trust classification.

5. The method of claim 4, wherein the trust classification indicates a trust relationship, an uncertain relationship, or an untrust relationship between each of the one or more first contacts connected to the searching entity.

6. The method of claim 1, wherein one or more contact paths transmitted to the searching entity comprise information relating to the one or more first contacts, a trust classification, and a distance indicator.

7. The method of claim 6, wherein the distance indicator indicates a number of contacts between the searching entity and the target contact.

8. The method of claim 1, further comprising downloading one or more contacts to the contacts database, wherein the one or more downloaded contacts are associated with a trust classification.

9. The method of claim 1, further comprising downloading information relating to the searching entity in a users database and the contacts database.

10. The method of claim 1, further comprising preventing a contact from being included in a contact path if a time period indicator indicates the contact is unavailable.

11. A computer system configured to search for a target contact from a plurality of contacts associated with one or more applications, comprising:
a processor;
memory in electronic communication with the processor;
a contact path generator module configured to:
receive a search request for the target contact from a searching entity;
retrieve information relating to the target contact from a contacts database;
identify one or more first contacts in the contacts database that connect to the searching entity;
if the one or more contacts do not connect to the target contact, identify one or more additional contacts in the contacts database until one or more of the additional contacts connect to the target contact; and
generate one or more contact paths from the searching entity to the target contact, wherein the one or more contact paths include one or more contacts between the searching entity and the target contact.

12. The computer system of claim 11, wherein the contact path generator module is further configured to transmit the one or more contact paths to the searching entity.

13. The computer system of claim 11, wherein the one or more applications comprise online social networking portals.

14. The computer system of claim 11, wherein each of the one or more first contacts connected to the searching entity comprises a trust classification.

15. The computer system of claim 14, wherein the trust classification indicates a trust relationship, an uncertain relationship, or an untrust relationship between each of the one or more first contacts connected to the searching entity.

16. The computer system of claim 15, wherein one or more contact paths transmitted to the searching entity comprise information relating to the one or more first contacts, a trust classification, and a distance indicator.

17. The computer system of claim 16, wherein the distance indicator indicates a number of contacts between the searching entity and the target contact.

18. The computer system of claim 11, wherein the contact path generator module is further configured to download one or more contacts to the contacts database, wherein the one or more contacts are associated with a trust classification.

19. A computer-program product for searching for a target contact from a plurality of contacts associated with one or more applications, the computer-program product comprising a computer-readable medium having instructions thereon, the instructions comprising:
code programmed to receive a search request for the target contact from a searching entity;
code programmed to retrieve information relating to the target contact from a contacts database;
code programmed to identify one or more first contacts in the contacts database that connect to the searching entity;
if the one or more contacts do not connect to the target contact, code programmed to identify one or more additional contacts in the contacts database until one or more of the additional contacts connect to the target contact; and
code programmed to generate one or more contact paths from the searching entity to the target contact, wherein the one or more contact paths include one or more contacts between the searching entity and the target contact.

20. A computer-implemented method for connecting a searching entity with a target contact through a contact path, comprising:
validating login credentials of the searching entity;
collecting one or more contacts of the searching entity;
applying a trust classification to each of the one or more collected contacts;
submitting a search request for the target contact;
receiving one or more contact paths from the searching entity to the target contact, wherein each contact path comprises one or more contacts between the searching entity and the target contact; and
transmitting a message from the searching entity to a first level of contacts connected to the searching entity;
if the message has not arrived at the target contact, forwarding the transmitted message from the first level of contacts to additional contacts on the contact patch until the message arrives at the target contact.
